(19) United States
(12) Patent Application Publication
(10) Pub. No.: US 2014/0022174 A1
(43) Pub. Date: Jan. 23, 2014

(54) EXTERNAL KEYBOARD AND SHEATH OF ELECTRONIC DEVICE

(71) Applicant: WISTRON CORPORATION, New Taipei City (TW)

(72) Inventor: YU-DAN CHEN, New Taipei City (TW)

(73) Assignee: Wistron Corporation, New Taipei City (TW)

(21) Appl. No.: 13/856,932

(22) Filed: Apr. 4, 2013

(30) Foreign Application Priority Data
Jul. 23, 2012 (CN) 201210256471.X

(51) Int. Cl. G06F 3/044

(52) U.S. Cl. CPC G06F 3/044
USPC 345/168

(57) ABSTRACT

An external keyboard of an electronic device having a capacitive touch screen and a connector socket is provided. The external keyboard includes a keyboard body and a plurality of physical buttons. The keyboard body is for being disposed on the capacitive touch screen and includes a connector connected to the connector socket. Each physical button has a trigger portion, and a top surface and a bottom surface opposite to each other, and the trigger portion is disposed between the top surface and the bottom surface. The physical buttons are disposed in the keyboard body at intervals. When a distance between the trigger portion and the capacitive touch screen is less than a trigger interval, capacitance of a region of the capacitive touch screen corresponding to the trigger portion is changed by the trigger portion to generate a touch signal. Furthermore, a sheath of an electronic device is also provided.

### CROSS-REFERENCES TO RELATED APPLICATIONS

This non-provisional application claims priority under 35 U.S.C. §119(a) on Patent Application No. 201210256471.X filed in China, on 2012 Jul. 23, the entire contents of which are hereby incorporated by reference.

### BACKGROUND OF THE INVENTION

1. Technical Field

The present invention relates to an external keyboard and a sheath of an electronic device, and particularly to an external keyboard and a sheath of an electronic device with a capacitive touch screen.

2. Related Art

As the touch technology has become increasingly popular, more and more electronic devices, such as smart phones or tablet computers, have completely adopted an operating system supporting touch technology and corresponding software and hardware thereof, and do not have physical keyboards, and often only physical buttons (for example, power buttons or volume buttons), of a few of common functions are retained on the device's main body.

For portable electronic devices completely adopting touch operations, any character input or other function operations (such as photographing and recording), can only be performed in a touch manner. Especially during a character operation, such as short message input or calendar editing, the operating system usually makes a virtual keyboard formed by a plurality of virtual buttons display on a touch screen, so that it is convenient for a user to input characters through the virtual buttons.

However, in order to satisfy the portable requirement of the user, the volume of the portable electronic device generally cannot be too large for the convenience of carrying, so the size of the touch screen is directly affected. The size of the common portable electronic device on the market is between 3.5 inches and 5 inches. In such a small display range, the size of the displayed virtual button is necessarily small. Since the size of the displayed virtual button is too small with respect to a finger, the user is likely make a wrong touch during operation.

Furthermore, since a capacitive touch screen is made of a rigid material, during the operation, reciprocating movement with the pressing of the finger cannot be incurred and appropriate force feedback cannot be generated, which is unlike the case of the physical keyboard, so when the user inputs a lot of characters through the virtual keyboard, finger discomfort is easily caused.

### SUMMARY

Accordingly, the present invention provides an external keyboard of an electronic device. The electronic device has a capacitive touch screen and a connector socket. The external keyboard includes a keyboard body and a plurality of physical buttons. The keyboard body is for being disposed on the capacitive touch screen and includes a connector connected to the connector socket. Each physical button has a trigger portion, and a top surface and a bottom surface opposite to each other, and the trigger portion is disposed between the top surface and the bottom surface. The physical buttons are disposed in the keyboard body at intervals. When a distance between the trigger portion and the capacitive touch screen is less than a trigger interval, a capacitance value of a local region of the capacitive touch screen corresponding to the trigger portion is changed by the trigger portion to generate a touch signal. A value of the trigger interval depends on the sensitivity with which each capacitive touch screen senses a change in capacitance.

Furthermore, a sheath of an electronic device is also provided, and includes an elastic frame body and the external keyboard. The elastic frame body has an inner edge and an outer edge. The elastic frame body sleeves a periphery of the capacitive touch screen through the inner edge thereof, and exposes a display surface of the capacitive touch screen. The external keyboard is connected to the outer edge of the elastic frame body in a flippable manner and is capable of rotating with respect to the capacitive touch screen. That is to say, when the external keyboard is required to be used, the external keyboard may be flipped over to be on the display surface of the capacitive touch screen, and then a touch operation is performed. When the external keyboard is not required, the external keyboard may be flipped over to the back of the capacitive touch screen.

In sum, the external keyboard or the sheath provided by the present invention enables a user to perform the touch operation through a physical keyboard, thereby solving the problem in the prior art that a wrong touch is easily performed or discomfort is easily caused when a lot of characters are input.

### BRIEF DESCRIPTION OF THE DRAWINGS

The present invention will become more fully understood from the detailed description given herein below for illustration only, and thus not limitative of the present invention, wherein:

FIG. 1 is a schematic diagram 1 of a first embodiment of the present invention;

FIG. 2 is a schematic diagram 2 of the first embodiment of the present invention;

FIG. 3 is a side view of the first embodiment of the present invention;

FIG. 4 is a schematic diagram 1 of a second embodiment of the present invention; and

FIG. 5 is a schematic diagram 2 of the second embodiment of the present invention.

### DETAILED DESCRIPTION

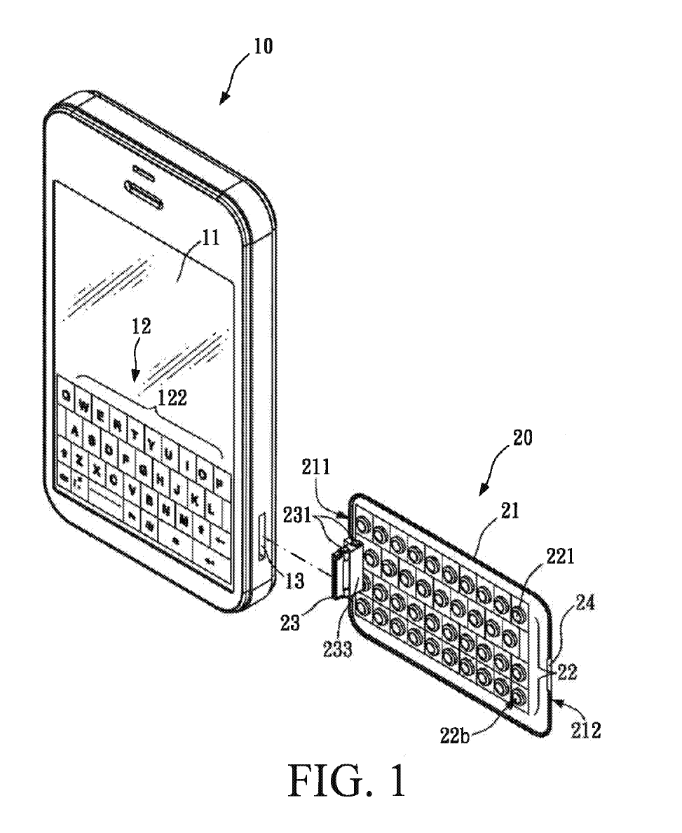

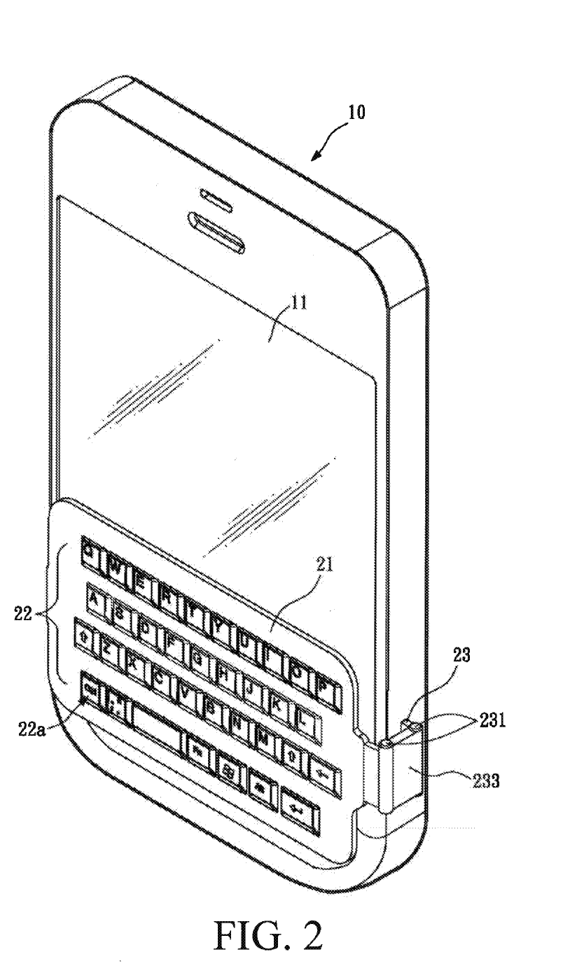

FIG. 1 is a schematic diagram 1 of a first embodiment of the present invention. FIG. 2 is a schematic diagram 2 of the first embodiment of the present invention. Please refer to FIG. 1 and FIG. 2, in which an external keyboard 20 of an electronic device 10 is disclosed. The electronic device 10 has a capacitive touch screen 11 and a connector socket 13. The external keyboard 20 includes a keyboard body 21 and a plurality of physical buttons 22.

The keyboard body 21 is for being disposed on the capacitive touch screen 11 and includes a connector 23 for being connected to the connector socket 13 of the electronic device 10.

Each physical button 22 has a trigger portion 221, and a top surface 22a and a bottom surface 22b opposite to each other. The trigger portion 221 is disposed between the top surface 22a and the bottom surface 22b, and the physical buttons 22 are disposed in the keyboard body 21 at intervals.

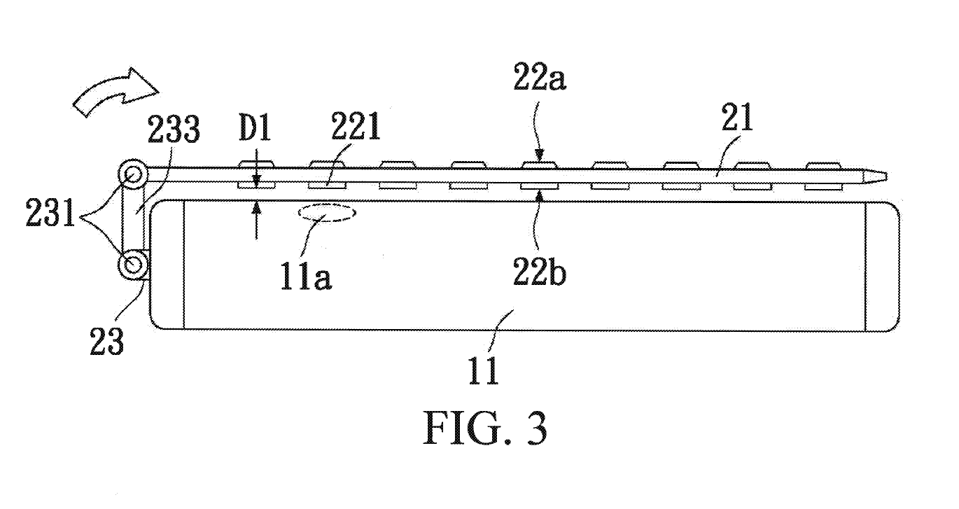

Please refer to FIG. 3, in which when the keyboard body 21 is disposed on the capacitive touch screen 11, as shown in FIG. 2, the trigger portion 221 and the capacitive touch screen 11 are apart by a preset interval D1. When the trigger portion 221 and the capacitive touch screen 11 are apart by the preset interval D1, a capacitance value of a local region 11a of the capacitive touch screen 11 corresponding to the trigger portion 221 is not changed by the trigger portion 221 or is changed very slightly, so the capacitive touch screen 11 does not generate a touch signal. When a distance between the trigger portion 221 and the capacitive touch screen 11 is less than a trigger interval or the trigger portion 221 directly contacts with the capacitive touch screen 11, the capacitance value of the local region 11a of the capacitive touch screen 11 corresponding to the trigger portion 221 is changed by the trigger portion 221, thereby generating a touch signal. Depending on the sensitivity with which each capacitive touch screen senses a change in capacitance, the value of the trigger interval varies. The more sensitive the capacitive touch screen is, the smaller the trigger interval is.

Please refer again to FIG. 1, in which the capacitive touch screen 11 of the electronic device 10 may display a virtual keyboard 12 formed of a plurality of virtual buttons 122, and each physical button 22 individually corresponds to each virtual button 122. The virtual keyboard 12 may be generated through an operating system of the electronic device 10. However, operating systems of manufactures are different (for example, Android, iOS, windows, and the like), and electronic devices of the same manufacture even have different input manners with respect to different models. Additionally, the same electronic device 10 may also generate various virtual keyboards with different key position configurations by switch an input method. Therefore, a button position configuration of each physical button 22 of the external keyboard 20 may be customized for the electronic device 10.

In an implementation aspect of the present invention, the external keyboard 20 further includes a processing module (not shown), which is disposed in the keyboard body 21 and has an inbuilt virtual keyboard generation program. When the connector 23 of the external keyboard 20 is connected electrically to the connector socket 13 of the electronic device 10, the processing module automatically executes the virtual keyboard generation program to output a control signal to the electronic device 10, so that the electronic device 10 displays a virtual keyboard 21 corresponding to the button positions of the physical buttons 22 on the capacitive touch screen 11 according to the control signal. The advantage of this implementation aspect is that the virtual keyboard 21 is generated by the processing module of the external keyboard 20, so the virtual keyboard 21 corresponding to the button positions of the physical buttons 22 can be generated on the electronic device 10 connected to the external keyboard 20 without customization, thereby improving the generality of the external keyboard 20.

Please refer again to FIG. 1, in which the keyboard body 21 has a first side edge 211 and a second side edge 212 opposite to each other, and the connector 23 is disposed on the first side edge 211. The keyboard body 21 further optionally includes a fixing member 24, for example, a fastening member, which is disposed on the second side edge 212 of the keyboard body 21. When the keyboard body 21 is disposed on the capacitive touch screen 11, the fixing member 24 is fastened on a side edge of the electronic device 10, so that the keyboard body 21 may be separably fixed on a display surface of the capacitive touch screen 11. The fixing member 24 of the present invention is not limited to the joining manner of fastening, may also vary according to the model of the electronic device 10, and may be changed to, for example, a magnetic joining manner or other manners, which is not limited in the present invention.

Please refer again to FIG. 1 to FIG. 3, in which the connector 23 further includes a plate body 233, and two rotary shafts 231 disposed at two sides of the plate body 233 in parallel. One of the rotary shafts 231 is pivotably connected to the first side edge 211 of the keyboard body 21, so that the keyboard body 21 can rotate with respect to the plate body 233 and rotate with respect to the capacitive touch screen 11. Through the rotary shafts 231 and the plate body 233, the keyboard body 21 may rotate with respect to the capacitive touch screen 11 regardless of the thickness of the electronic device 10. A distance between the two rotary shafts 231 is approximately half of the thickness of the electronic device 10, but the present invention is limited thereto as long as the keyboard body 21 can be disposed on the display surface of the capacitive touch screen 11 in parallel.

The physical button 22 of this embodiment, except for the trigger portion 221, is made of an elastic material, for example, silica gel or rubber. The purpose of using the elastic material is to use the elasticity of the material to avoid finger discomfort caused in the situation that a user operates the external keyboard 20 for a long time. The trigger portion 221 must be made of an electrically conductive material, for example, a metal material such as stainless steel or iron, so as to, when the distance between the trigger portion 221 and the capacitive touch screen 11 is less than the trigger interval or the trigger portion 221 directly contacts with the capacitive touch screen 11, enable the capacitance value of the local region 11a of the capacitive touch screen 11 to be changed, and enable the capacitive touch screen 11 to generate a touch signal.

In an implementation aspect, two ends of the trigger portion 221 are flush with the top surface 22a and the bottom surface 22b, so that when touching the top surface 22a of the physical button 22, a finger of the user can directly contact with an end surface of the trigger portion 221.

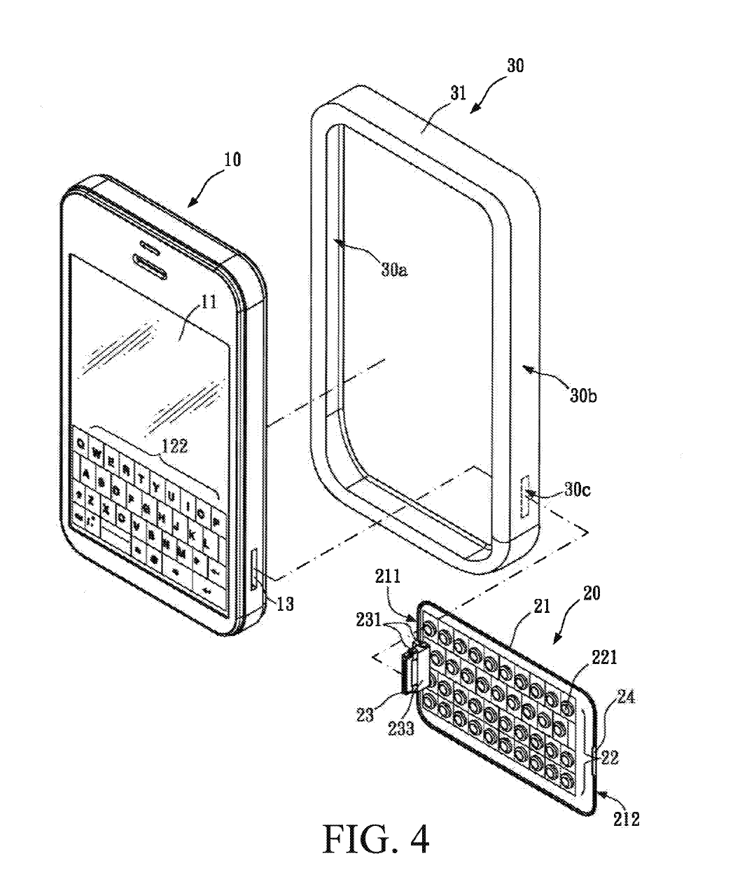

FIG. 4 is a schematic diagram 1 of a second embodiment of the present invention. FIG.

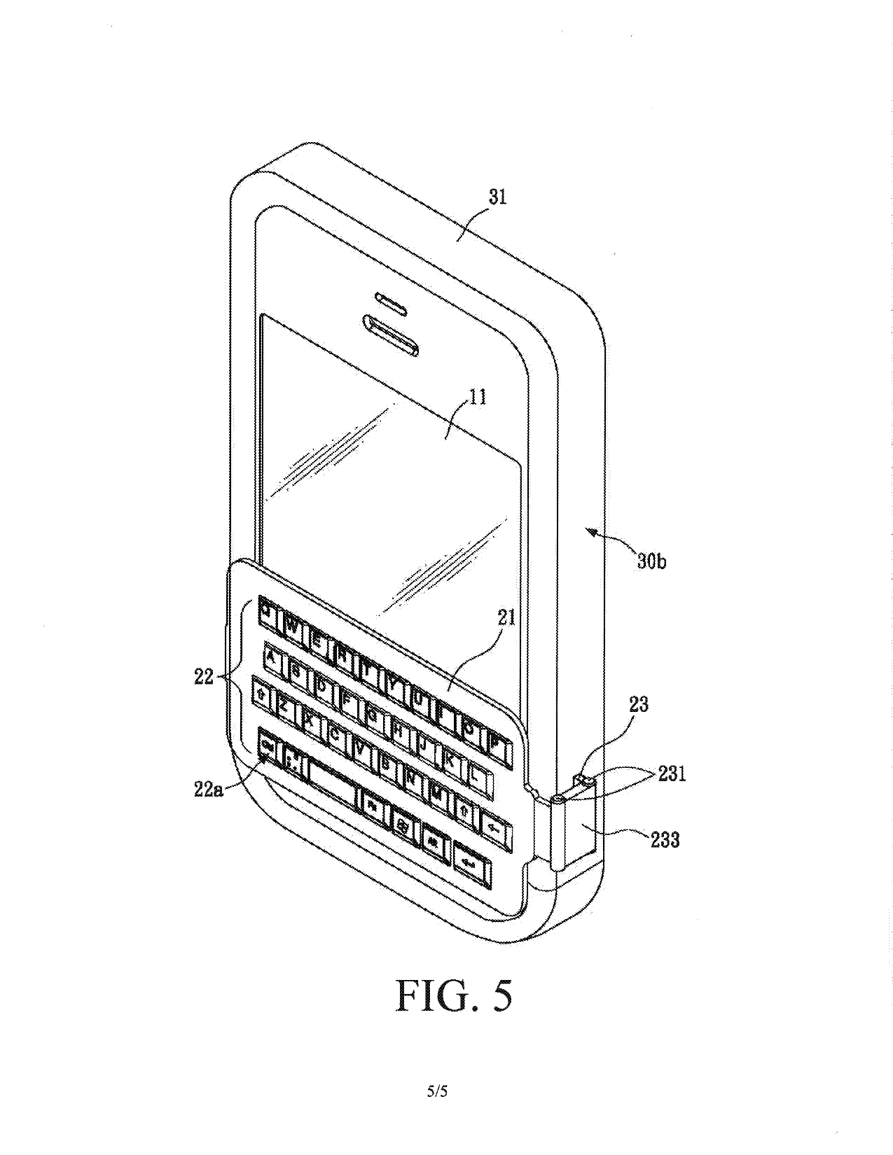

5 is a schematic diagram 2 of the second embodiment of the present invention. Please refer to FIG. 4 and FIG. 5, in which a sheath 30 of an electronic device is disclosed. As described in the foregoing embodiment, the electronic device 10 has a capacitive touch screen 11 and a connector socket 13. The capacitive touch screen 11 has a display surface. The sheath 30 includes an elastic frame body 31 and an external keyboard 20.

The elastic frame body 31 has an inner edge 30a, an outer edge 30b, and a through hole 30c. When the elastic frame body 31 sleeves a periphery of the capacitive touch screen 11 through the inner edge 30a, the through hole 30c exactly corresponds to a connector socket 13 and the display surface of the capacitive touch screen 11 is exposed.

The so-called external keyboard in this embodiment is the same as the external keyboard disclosed in the foregoing embodiment. The connector 23 is inserted into the connector socket 13 through the through hole 30c and is connected electrically to the connector socket 13. Furthermore, the keyboard body 21 of the external keyboard 20 and the elastic frame body 31 may be integrally formed, that is, are both made of an elastic material. In this way, not only the periphery of the capacitive touch screen 11 is protected by the elastic frame body 31, but also the display surface of the capacitive touch screen 11 is protected by the external keyboard 20. Additionally, when the external keyboard 20 is not required for input, after the external keyboard 20 is flipped over to the back of the capacitive touch screen 11, the electronic device 10 can be placed on any object surface for operation without worrying about incurring of scratches or wear to the back of the capacitive touch screen.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An external keyboard of an electronic device, wherein the electronic device has a capacitive touch screen and a connector socket, the external keyboard comprising:
a keyboard body, for being disposed on the capacitive touch screen, and comprising a connector for being connected to the connector socket; and
a plurality of physical buttons, disposed on the keyboard body at intervals, wherein each physical button has a trigger portion, and a top surface and a bottom surface opposite to each other, and the trigger portion is disposed between the top surface and the bottom surface,
wherein when a distance between the trigger portion and the capacitive touch screen is less than a trigger interval, capacitance of a local region of the capacitive touch screen corresponding to the trigger portion is changed by the trigger portion to generate a touch signal.

2. The external keyboard of an electronic device according to claim 1, wherein the capacitive touch screen displays a virtual keyboard formed of a plurality of virtual buttons, and each physical button individually corresponds to each virtual button.

3. The external keyboard of an electronic device according to claim 2, further comprising a processing module disposed in the keyboard body, wherein the connector is connected electrically to the connector socket, and the processing module outputs a control signal to the electronic device when the connector is connected electrically to the connector socket, so that the electronic device displays the virtual keyboard on the capacitive touch screen according to the control signal.

4. The external keyboard of an electronic device according to claim 1, wherein the keyboard body has a first side edge and a second side edge opposite to each other, the connector is disposed on the first side edge, the keyboard body further comprises a fixing member disposed on the second side edge of the keyboard body, and the keyboard body is separably fixed on a display surface of the capacitive touch screen through the fixing member.

5. The external keyboard of an electronic device according to claim 4, wherein the connector further comprises a first rotary shaft pivotably connected to the first side edge of the keyboard body, so that the keyboard body is capable of rotating with respect to the connector.

6. The external keyboard of an electronic device according to claim 5, wherein the connector further comprises a plate body and a second rotary shaft, the first rotary shaft and the second rotary shaft are disposed at two sides of the plate body respectively to enable the plate body to rotate with respect to the first rotary shaft and the second rotary shaft, and the first rotary shaft pivots the plate body to the first side edge.

7. The external keyboard of an electronic device according to claim 1, wherein the physical button, except the trigger portion, is made of an elastic material.

8. The external keyboard of an electronic device according to claim 1, wherein the trigger portion is made of a metal material.

9. The external keyboard of an electronic device according to claim 1, wherein when the keyboard body is disposed on the capacitive touch screen, the trigger portion and the capacitive touch screen are apart by a preset interval, and the preset interval is greater than the trigger interval.

10. A sheath of an electronic device, wherein the electronic device has a capacitive touch screen and a connector socket, and the capacitive touch screen has a display surface, the sheath comprising:
an elastic frame body, having an inner edge, an outer edge, and a through hole, wherein the through hole communicates the inner edge with the outer edge, and the elastic frame body sleeves a periphery of the capacitive touch screen through the inner edge, and exposes the display surface of the capacitive touch screen; and
the external keyboard according to claims 1, wherein the through hole corresponds to the connector socket, and the connector is inserted into the connector socket through the through hole.

11. The sheath of an electronic device according to claim 10, wherein the capacitive touch screen displays a virtual keyboard formed of a plurality of virtual buttons, and each physical button individually corresponds to each virtual button.

12. The sheath of an electronic device according to claim 11, further comprising a processing module disposed in the keyboard body, wherein the connector is connected electrically to the connector socket, and the processing module outputs a control signal to the electronic device when the connector is connected electrically to the connector socket, so that the electronic device displays the virtual keyboard on the capacitive touch screen according to the control signal.

13. The sheath of an electronic device according to claim 10, wherein the keyboard body has a first side edge and a second side edge opposite to each other, the connector is disposed on the first side edge, the keyboard body further comprises a fixing member disposed on the second side edge of the keyboard body, and the keyboard body is separably fixed on a display surface of the capacitive touch screen through the fixing member.

14. The sheath of an electronic device according to claim 13, wherein the connector further comprises a first rotary shaft pivotably connected to the first side edge of the keyboard body, so that the keyboard body is capable of rotating with respect to the connector.

15. The sheath of an electronic device according to claim 14, wherein the connector further comprises a plate body and a second rotary shaft, the first rotary shaft and the second rotary shaft are disposed at two sides of the plate body respectively to enable the plate body to rotate with respect to the first rotary shaft and the second rotary shaft, and the first rotary shaft pivots the plate body to the first side edge.

16. The sheath of an electronic device according to claim 10, wherein the physical button, except the trigger portion, is made of an elastic material.

17. The sheath of an electronic device according to claim 10, wherein the trigger portion is made of a metal material.

18. The sheath of an electronic device according to claim 10, wherein when the keyboard body is disposed on the capacitive touch screen, the trigger portion and the capacitive touch screen are apart by a preset interval, and the preset interval is greater than the trigger interval.
